(19) United States
(12) Patent Application Publication
(10) Pub. No.: US 2020/0377237 A1
(43) Pub. Date: Dec. 3, 2020

(54) Spacecraft Mass Shifting With Propellant Tank Systems

(71) Applicant: Xplore Inc., Mercer Island, WA (US)

(72) Inventors: John Eric Hanson, Mountain View, CA (US); Adam Richard Schilffarth, Mill Creek, WA (US)

(21) Appl. No.: 16/838,414

(22) Filed: Apr. 2, 2020

Related U.S. Application Data
(60) Provisional application No. 62/828,891, filed on Apr. 3, 2019.

(51) Int. Cl. B64G 1/40; B64G 1/28

(52) U.S. Cl. CPC B64G 1/402; B64G 1/283

(57) ABSTRACT

Systems, apparatuses, methods, and software are described herein that provide enhanced logistical control over spacecraft. This logistical control can include attitude adjustment and desaturation of reaction wheels. In one example, a method of operating a spacecraft includes providing propellant in two or more propellant tanks for use by at least a thruster of the spacecraft. During application of a force on the spacecraft, the method includes transferring propellant from at least a first propellant tank to at least a second propellant tank to alter a center of mass of the spacecraft.

### RELATED APPLICATIONS

This application hereby claims the benefit of and priority to U.S. Provisional Patent Application No. 62/828,891, titled “SPACECRAFT MASS SHIFTING TANK SYSTEMS,” filed Apr. 3, 2019, which is hereby incorporated by reference in its entirety.

### BACKGROUND

Spacecraft can be launched into Earth orbit, heliocentric orbit, and into other trajectories to facilitate various tasks, such as exploration, communications, science payload deployment, imaging, or analysis, among other tasks. Some of these spacecraft comprise satellites which remain in Earth orbit or other planetary orbits to perform various specialized roles. Typically, spacecraft can be commanded to change orientation or orbit using on-board thrusters, engines, gyroscopic elements, or reaction wheels, among other elements to reach a desired orientation or orbit. However, a fixed amount of propellant or power might be available to perform these changes, which can also limit the quantity of the changes or the magnitude of the changes.

### OVERVIEW

Systems, apparatuses, methods, and software are described herein that provide enhanced logistical control over spacecraft. This logistical control can include attitude adjustment and desaturation of reaction wheels. In one example, a method of operating a spacecraft includes providing propellant in two or more propellant tanks for use by at least a thruster of the spacecraft. During application of a force on the spacecraft, the method includes transferring propellant from at least a first propellant tank to at least a second propellant tank to alter a center of mass of the spacecraft.

This Overview is provided to introduce a selection of concepts in a simplified form that are further described below in the Technical Disclosure. It should be understood that this Overview is not intended to identify key features or essential features of the claimed subject matter, nor should it be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a spacecraft according to an implementation.

FIG. 2 illustrates a method of producing torque on a spacecraft according to an implementation.

FIG. 3 illustrates an example spacecraft center-of-mass management system according to an implementation.

FIG. 4 illustrates a comparison among spacecraft torque configurations.

FIG. 5 illustrates an example three propellant tank topology.

FIG. 6 illustrates an example two propellant tank topology.

FIG. 7 illustrates an example three propellant tank topology.

FIG. 8 illustrates an example three propellant tank topology.

FIG. 9 illustrates an example spacecraft center-of-mass management system according to an implementation.

FIG. 10 illustrates an example spacecraft center-of-mass management system according to an implementation.

### DETAILED DESCRIPTION

Spacecraft include various components to perform one or more mission tasks during deployment. These components can include various mission payload systems, logistical control systems including propulsion or orientation control systems, and structural or chassis elements. On-board power sources or power generation components can also be included. Once deployed into orbit or other trajectories, the spacecraft can be directed to change orbits, orientations, or attitudes using on-board logistical control components, which might include thrusters, engines, gyroscopic elements, or reaction wheels, among other components. Components which alter an orientation or pointing direction of a spacecraft can be referred to as attitude determination and control systems (ADCS). Components which propel a spacecraft to a greater velocity or change the direction of the velocity can be referred to as propulsion systems. Many spacecraft can employ reaction control systems (RCS) comprising cold-gas or hot-gas thrusters to produce changes in orientation, pointing direction, or attitude or manage the accumulation of angular momentum by other components such as reaction wheels or control moment gyroscopes. However, these cold-gas or hot-gas thrusters require specialized on-board gas/liquid, reservoirs, and output nozzles or other output and control elements. The examples discussed herein can reduce or eliminate the need for cold-gas or hot-gas thrusters, other thruster elements dedicated to attitude control as well as decrease the amount of propellant needed for the duration of the mission. The term ‘thrusters’ is used herein to refer to both propulsion engines of a spacecraft and RCS cold/hot gas thrusters, and it should be apparent from the accompanying descriptions as to which component is described in each instance.

Even when a spacecraft includes on-board attitude adjustment equipment, a limited amount of adjustment might be achievable given a particular set of components. For example, reaction wheels might provide for some orientations or attitude controls over a range of angular momentum changes before a maximum limit is reached, referred to as reaction wheel saturation. Cold-gas or hot-gas thrusters can provide for similar orientation or attitude adjustments, but have limited on-board gas quantities and require associated control mechanisms. When chemical propellants are employed, the quantity of chemical propellant is tied to the life of the mission. This limit to mission life results in part from the need to unload the angular momentum in the attitude control system. Numerous techniques, such as exploiting radiation pressure and careful mission management of payload pointing rates, have been developed to minimize the number, duration, and magnitude of angular momentum unloading firings. Mechanical solutions such as gimballing a thruster have improved spacecraft lifetime by providing more degrees of freedom to unload angular momentum of the attitude control system. However, use of a gimbal results in increased mass and cost, as well as lower resultant spacecraft acceleration, performance, and reliability.

Discussed herein are several enhanced techniques and systems to increase the mission life of spacecraft of various types. By extending the life of spacecraft, otherwise nominally healthy vehicles can have extended missions. A reduction in the wasteful use of chemical propellant for attitude control can also be achieved. The examples herein employ a propellant mass management system capable of advantageously shifting a location of a spacecraft center of mass (CoM). This system allows management of propellant reservoirs associated with primary propulsion engines of a spacecraft to affect angular momentum management and reduce the need for life-limiting and low-efficiency chemical propulsion systems. Thus, CoM management systems described herein can advantageously achieve enhanced operations utilizing one or more electric propulsion thrusters in tandem with management of on-board propellant reservoirs.

Spacecraft CoM can be altered, in the examples herein, using on-board propellant of any kind. This on-board propellant can be shifted among different reservoirs or locations to correspondingly alter a CoM of the spacecraft. Propellant can be shifted among reservoirs or locations using various mechanisms that produce pressure differentials among these various reservoirs or across valve mechanisms, such as via pumps, mechanical compression of reservoirs, and heating elements proximate to propellant reservoirs. Advantageously, the CoM of a spacecraft can be altered dynamically while the spacecraft is undergoing a continuous thrust, such as from a propulsion system. Various equipment can be included on the spacecraft to shift mass from one location on the spacecraft to another, altering the CoM of the spacecraft accordingly. In one example, a pump can be used for moving propellant form one tank to a second tank to alter or shift a center of mass of a spacecraft. In another example, propellant can be transferred from a first tank to a second tank through the application of heat to the first tank to be evacuated, which would induce a pressure differential across a valve common to the two tanks. When temperature-induced pressure differential reaches a threshold, the common valve would open allowing propellant to flow from a heated tank to a non-heated tank. This would advantageously result in a center of mass shift of a spacecraft.

Moreover, the CoM management examples herein reduce spacecraft complexity and increase mission assurance. For example, in the temperature-induced pressure differential examples, a propellant transfer pump can be omitted in lieu of a valve and heater. This can reduce the number of possible mechanical failure modes on the spacecraft. Although pump-based CoM shifting can operate over a large range of flow rates, the temperature-induced examples might be better suited to smaller volumetric flow rates of propellant.

In operation, a spacecraft can provide thrust using propellant. However, the CoM management system discussed herein dynamically change CoM properties of a spacecraft while under thrust. The CoM management system employs components of on-board propulsion systems and move propellant mass via a combination of pumps or selective heating to favorably move the center of mass of the spacecraft and manage the spacecraft CoM. By negating the need for a secondary attitude determination and control system (ADCS), secondary propulsion system, or a complicated engine gimbaling system, the spacecraft acceleration performance provided by the CoM management system is increased by the resulting mass savings.

The CoM management system provides a means to manage angular momentum without the use of chemical consumables in at least two beneficial ways. A first benefit employs a physical offset between each thruster and the spacecraft CoM so that torques induced during attitude adjustment maneuvers act to de-spin on-board reaction control wheels. A second benefit is the ability to manipulate the spacecraft inertia matrix while maneuvering to manage angular momentum in all three axes. Adjusting the inertia tensor (matrix) can be useful for precision pointed spinning spacecraft. In this way, the CoM management system more efficiently uses the on-board propellant for both maneuver and angular momentum management, without the need for a secondary chemical propulsion system or mechanical gimbals. By reducing the spacecraft mass and complexity, electric propulsion systems utilizing the CoM management system can trade leveraging the increase in acceleration performance with additional onboard propellant to increase mission lifetime. Also, with the CoM management system, electric propulsion can realize greater potential and enable the next generation of dynamic, extended duration missions. In one example, a mission using electrically-powered spacecraft propulsion thrusters might include 5 kg of additional xenon fuel, and mission lifetime could be extended by an estimated 5.2 years using the CoM management system.

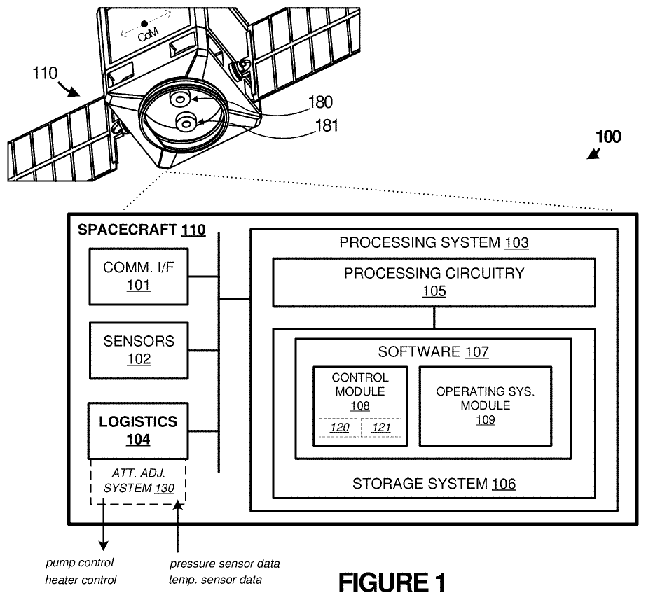

To further illustrate an example of enhanced spacecraft, FIG. 1 is presented. FIG. 1 illustrates an expanded view 100 of spacecraft 110 capable of providing a platform for space exploration, communication, sensing, or other missions according to an implementation. Spacecraft 110 is representative of any spacecraft, space probe, or satellite system/systems with which the various operational architectures, processes, scenarios, and techniques disclosed herein for a space vessel may be implemented. Spacecraft 110 comprises communication interface 101, sensors 102, processing system 103, and logistics 104. Processing system 103 is communicatively linked to at least communication interface 101, sensors 102, and logistics 104. Spacecraft 110 may include other components such as batteries, solar panels, antennas, communication arrays, chassis elements, bus elements, and enclosures that are not shown for clarity.

Communication interface 101 comprises communication signal receiving and transmitting structures. Communication interface 101 is configured to transmit information signals that may contain navigation instructions, operating commands, or data representing the detected characteristics of target objects if one or more sensors are employed on spacecraft 110. Communication interface 101 is configured to receive further information signals transmitted to the spacecraft, such as for instructions on when to transmit the detected characteristics/data, commands for sequencing of maneuvers, timing, logistics control, software control, on-board control system management, or other functions. Communication interface 101 comprises components that communicate over communication links, such as network cards, communication ports, cable ports, radio frequency (RF) circuitry, processing circuitry and software, or some other communication devices. Communication interface 101 may be configured to communicate over wireless RF links or optical links. Communication interface 101 may be configured to use various multiplexing protocols, wireless communication protocols, communication signaling protocols, Internet Protocol (IP), or some other communication format, including combinations thereof. In some implementations, communication interface 101 may communicate with one or more other spacecraft in a spacecraft formation or constellation or communicate with ground/base control systems.

Sensors 102 may comprise detection structures and systems designed to measure at least one characteristic of target objects. Sensors 102 may comprise imaging sensors, heat sensors, light sensors, radar sensors, lidar sensors, electromagnetic sensors, acoustic sensors, particle sensors, or some other type of sensor. Sensors 102 can also include various sensors and systems for monitoring behavior, state, and performance of elements of spacecraft 110, such as reaction wheel speed sensors, sensors for measuring spacecraft angular velocity, accelerometers, gyroscopes, heat/temperature sensors, propellant tank sensors, and other sensors. Sensors 102 might provide sensor data for various characteristics for use as attitude adjustment parameters 120 with attitude adjustment control 121, discussed below.

Logistics 104 comprises various equipment related to motion, acceleration, attitude, or orientation of spacecraft 110. Logistics 104 can be configured to adjust speed, velocity, orientation, attitude, torque, or other physical characteristics of spacecraft 110. In one example, logistics 104 includes a propulsion system which pushes spacecraft 110 using one or more engines or thrusters. These thrusters can include chemically-powered thrusters, nuclear-powered thrusters, or electrically-powered spacecraft propulsion thrusters. Electrically-powered thrusters might derive electrical power from on-board solar panels, referred to as solar-electric propulsion (SEP), or might use other electrical power sources, such as nuclear-thermal, chemical batteries, capacitance elements, or other similar components. Example electrically-powered thrusters include hall effect thrusters, ion thrusters, electrothermal thrusters, plasma propulsion thrusters, or others, including combinations thereof. In one example, spacecraft 100 includes two Busek BHT-200 hall effect thrusters, shown by thrusters 180-181 in FIG. 1.

Logistics 104 can also comprise center of mass (CoM) control elements. In one example, these CoM control elements are provide by attitude adjustment system 130 which further comprises elements 120-121. Attitude adjustment system 130 can include traditional attitude adjustment components, such as cold-gas or hot-gas thrusters, reaction wheels, and control moment gyroscopes. However, in the examples herein, attitude adjustment system 130 includes an enhanced spacecraft CoM management system or propellant management system which is employed to alter a CoM of spacecraft 110. The CoM of spacecraft 110 can be altered by shifting propellant mass to different locations within spacecraft 110, such as among different reservoirs or tanks. Center of mass (CoM) control elements comprise pumps, pumping mechanisms, valves, associated pressure tubing/lines, pump control circuitry, pump power circuitry, pump control mechanisms, and other similar components. In some examples, center of mass (CoM) control elements include heaters or heating elements, along with heater control circuitry and heater power circuitry. Furthermore, center of mass (CoM) control elements can include various circuitry, sensors, control interfaces, and associated equipment to monitor pressures, temperatures, flow rates, and status of the various center of mass (CoM) control components. When heaters are included, corresponding temperature sensors can be employed can monitor temperatures of the heating elements as well as of the various reservoirs and the spacecraft itself.

Processing system 103 includes processing circuitry 105 and storage system 106 that stores operating software 107 as well as data related to detected characteristics for target objects. Processing circuitry 105 comprises microprocessor and other circuitry that retrieves and executes operating software 107 from storage system 106 to at least produce operations related to an enhanced spacecraft CoM management system. Storage system 106 may include volatile and nonvolatile, removable and non-removable media implemented in any method or technology for storage of information, such as computer readable instructions, data structures, program modules, or other data. Storage system 106 may be implemented as a single storage device, but may also be implemented across multiple storage devices or sub-systems. Storage system 106 may comprise additional elements, such as a controller to read operating software 107. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory.

Processing circuitry 105 is typically mounted on one or more circuit boards that may also hold storage system 106 and portions of communication interface 101 and sensors 102. Operating software 107 comprises computer operating systems, applications, programs, firmware, or some other form of machine-readable program instructions. Operating software 107 includes control module 108 and operating system module 109, although any number of software modules may provide various operations. Operating software 107 may further include utilities, drivers, network interfaces, applications, or some other type of software. When executed by processing circuitry 105, operating software 107 directs processing system 103 to operate spacecraft 110 as described herein.

Spacecraft 110 includes control module 108, which is used as a flight control system for the spacecraft. Control module 108 can be responsible for controlling communication interfaces 101, sensors 102, and logistics 104 of spacecraft 110. Control module 108, which may operate using processing circuitry on spacecraft 110, may be responsible for power management and flight control of the spacecraft, such as instructing engines or thrusters to execute attitude control operations, orientation changes, mass shifting operations, mass pumping operations, thermal heating operations, change in velocity (delta V) operations, delta V adjustments, or other operations. These operations may include managing the deployment of solar panels on the spacecraft, managing the positioning of the spacecraft with regards to target objects or other space bodies, or any other similar operation.

Storage system 106 includes further data and instructions which can be employed, altered, or executed by processing system 103 and processing circuitry 105, among other elements. In FIG. 1, these further data and instructions include attitude adjustment parameters 120 and attitude adjustment control 121 which comprise or control a CoM management system for spacecraft 110. Attitude adjustment parameters 120 and attitude adjustment control 121 can comprise elements of an attitude determination and control system (ADCS).

Attitude adjustment parameters 120 include algorithms, policies, characteristics, and measured state or sensor data for executing attitude adjustments to place spacecraft 110 into a different orientation or place a desired torque on spacecraft 110. Attitude adjustment parameters 120 might include data indicating present orientations, relative speed, velocity, acceleration, pitch/roll/yaw, or other information of spacecraft 110. Attitude adjustment parameters 120 might include a measurement of reaction wheel control moment gyroscope speeds and orientations. Attitude adjustment parameters 120 can record sensor input from various on-board logistical control equipment, such as information or data from star trackers, gyroscopic elements, accelerometers, measurement systems, dead-reckoning systems, thruster efficiency, thruster output, propellant levels, tank fullness status, or other various logistical control and monitoring information. Selection among attitude adjustment algorithms and techniques can be made based on this input data or information.

Attitude adjustment control 121 processes various information, such as that of attitude adjustment parameters 120, to produce and control changes in attitude for spacecraft 110. Attitude adjustment control 121 can move the CoM of spacecraft 110 by controlling movement of gas or liquid between two or more tanks. This can include controlling various elements of logistics 104, such as the enhanced center of mass adjustments discussed herein. Attitude adjustment control 121 can control pumping elements, valves, heating elements, or other mass/flow control elements. Attitude adjustment control 121 can comprise software to control pumps or heaters to adjust a location of a CoM for spacecraft 110. A combination of enhanced CoM adjustment and traditional attitude adjustment can be employed on spacecraft 110 and controlled by attitude adjustment control 121. For example, attitude adjustment control 121 can control gimbal on engines to control attitude, or activate cold-gas or hot-gas thrusters, spin up/down inertial/reaction wheels, among other operations.

In further examples, attitude adjustment control 121 can control torque applied to spacecraft 110 to desaturate reaction wheels. Reaction wheels might have limitations in adjustment, such as due to spin speed limitations, reaction wheel mass, maximum angular momentum, orientation limitations, or other limitations. When these limitations are reached, then attitude adjustment control 121 can employ an enhanced CoM adjustment to bring the reaction wheels away from any limits. This can be achieved by controlling torque exhibited on the spacecraft using the enhanced CoM adjustment. Attitude adjustment control 121 can control the magnitude and direction of a torque on a spacecraft produced by a thruster by moving the CoM of the vehicle. By moving the CoM to control torque, attitude adjustment control 121 reduces the need for a separate propulsion system to counter the torque produced by the engine, and can eliminate the need for gimbaling of thrusters. Moreover, attitude adjustment control 121 can control the magnitude and direction of a torque on a spacecraft produced by an external force (e.g. aerodynamic forces, impinging particulates, or solar pressure) by altering the center-of-mass of the spacecraft.

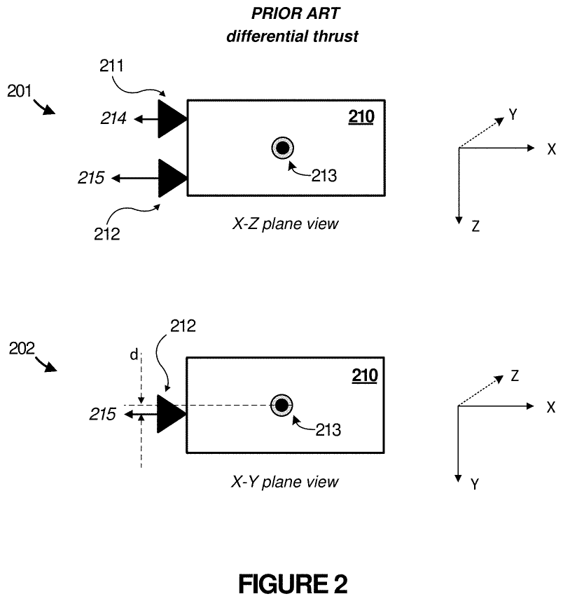

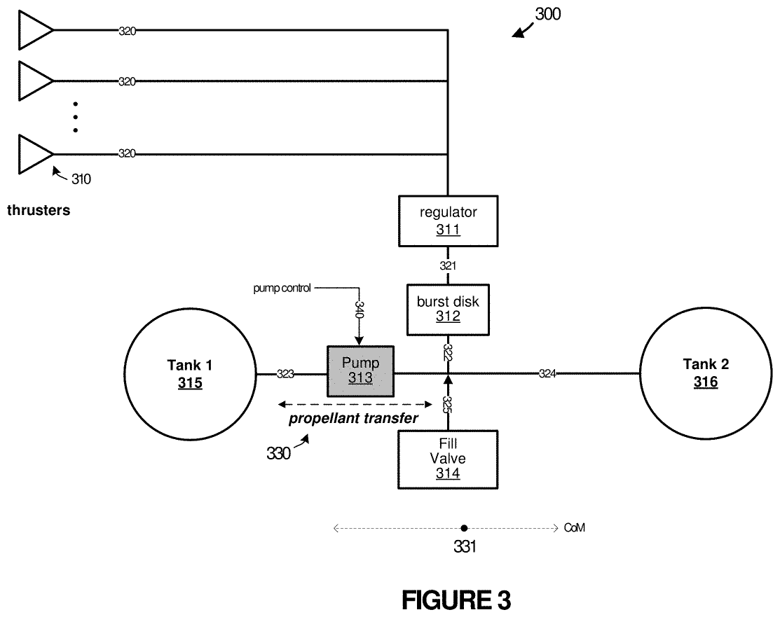

FIG. 2 is provided to illustrate existing types of spacecraft torque control. However, the configurations of FIG. 2 employ various undesirable techniques and equipment to produce these changes in torque for spacecraft 210. Spacecraft 210 has center of mass 213 and employs reaction wheels which can saturate under certain conditions, requiring separate cold-gas or hot-gas thrusters to desaturate them. Spacecraft 210 might instead employ a roll operation which requires additional movement with undesirable effects. These disadvantages are discussed below and in FIG. 3. However, the enhanced spacecraft CoM management systems discussed herein can be used to desaturate reaction wheels and produce torques on a spacecraft which avoids many of the disadvantages in FIG. 2.

More specifically, FIG. 2 is provided to illustrate example operations of systems and components that comprise conventional attitude control systems. In FIG. 2, a propulsion system of solar-electric propulsion (SEP) comprising thrusters 211-212 is employed, although the operations can apply to other types of propulsion. This example details SEP pitch torque, which can be caused due to imbalance of center-of-mass 213 with regard to thrusters 211-212. In a dual-SEP arrangement, such as the X-Z plane view shown in view 201, thrusters 211-212 are separated by an associated distance in the Z axis. Yaw torque is provided by differential thrust among thrusters 211-212, such as by controlling a duty cycle or relative amount of thrust of thrusters 211-212. However, pitch control in the Y axis is lacking in this configuration. Uncertainty in CoM 213 of spacecraft 210 (shown in FIG. 2 as ‘d’), along with spacecraft drift, can lead to a constant pitch torque on spacecraft 210. This constant pitch torque can lead to problems in orientation of spacecraft 210. Reaction wheels can be employed to correct for some amount of pitch torque. Also, pitch torque can change direction (sign) when spacecraft 210 is deployed into an orbital configuration. However, during long cruise or orbital periods, reaction wheels can become saturated before the pitch torque changes direction enough to desaturate the reaction wheels. Thus, using differential thrust among thrusters 211-212 can lead to problems over time for control of spacecraft 210. However, the enhanced spacecraft CoM management systems discussed herein can be used to desaturate reaction wheels.

SEP angular momentum unloading can also be discussed in the context of FIG. 2. In a dual-SEP arrangement, such as the X-Z plane arrangement shown in view 201 of FIG. 2, two thrusters are separated by an associated distance in the Z axis. Yaw torque is provided by differential thrust among thrusters 211-212, such as by controlling a duty cycle or relative amount of thrust of thrusters 211-212. Uncertainty in CoM 213 (shown in FIG. 2 as ‘d’), along with drift of spacecraft 210, can lead to a constant pitch torque. This can lead to problems in orientation of an associated spacecraft. Also, pitch torque can change direction (sign) when spacecraft 210 is deployed into an orbital configuration. However, during long cruise or orbital periods, reaction wheels can become saturated before the pitch torque changes enough to desaturate the reaction wheels. Spacecraft 210 can be rolled 90 degrees in orientation to unload pitch angular momentum. Roll torque can be provided using an on-board RCS, such as a cold-gas or hot-gas thruster system. Once rolled into the new orientation, then the dual-SEP thrusters can be used to unload the pitch angular momentum. This unloading can refer to a reduction in angular momentum stored or ‘loaded’ in associated reaction wheels, such as a reduction in speed.

Turning now to a discussion on example systems and elements which comprise an enhanced spacecraft CoM management system, FIG. 3 is provided. FIG. 3 illustrates a spacecraft thruster system block diagram 300 including a plurality of thrusters 310 having propellant sourced from a plurality of propellant tanks 315-316. In FIG. 3, three thrusters and two tanks are shown, but it should be understood that a different number of thrusters and tanks can instead be included. Thrusters 310 in FIG. 3 are coupled to regulator 311 which controls a pressure or flow of propellant to each thruster. For example, when an inert gas, such as xenon, is employed as the propellant, then regulator 311 can control a flow rate of the inert gas over lines 320 to each thruster. Burst disk 312 can be included to prevent damage to the system during overpressure events. Regulator 311 and burst disk 312 are coupled over line 321, and burst disk 312 can receive propellant from both tanks 315-316 over line 322.

Two propellant tanks 315-316 are included (tank 1 and tank 2) which store an amount of propellant. Fill valve 314 is included to initially fill tanks 315-316 through line 325, typically prior to deployment of an associated spacecraft. The amount of propellant stored at any given time can be controlled by a control system (not shown for clarity) coupled over link 340 and included pump 313. Pump 313 creates a pressure differential among tank 1 and tank 2 over lines 323-324 to move mass in the form of propellant among the tanks. Pump 313 (or any of the pumps discusses herein) might comprise an axial-flow, centrifugal, cross-flow pump, or micro-pump, among other configurations. Other pressure differential systems can be included instead of a pump, such as heater-based systems, which will be discussed below. A control system (not shown for clarity) can monitor a CoM 331 of an associated spacecraft and adjust the amount of propellant within each tank using the pump. CoM 331 can be monitored by tracking amounts of propellant presently in each tank, or by direct measurement by movement characteristics of the spacecraft. More than one pump might be included, such as redundant or parallel pumps. Also, as will be discussed below, various other example tank/pump configurations might be employed.

Using the system shown in FIG. 3 and examples in the Figures below, a spacecraft can exert small forces on itself by using a propulsion system, such as hall effect thrusters. These small forces can be on the order of millinewtons (mN) that create an unbalanced configuration during thrusting or during application of an external force on the spacecraft due in part to a misalignment between the thrust or force direction and the spacecraft CoM, thus inducing a torque on the spacecraft. During operation, an engine force provided by thrusters might not aligned with a present CoM of the spacecraft. In other examples, an external force might be experienced by the spacecraft due to solar wind, solar pressure, or other externally-applied forces. Reaction wheels can be traditionally used to counteract torques induced on the spacecraft by a mis-aligned CoM. However, reaction wheels may saturate if too large or too long of an unbalance is experienced. The enhanced spacecraft CoM management system discussed in FIG. 3 can not only provide correction torque to a spacecraft, but also can desaturate reaction wheels by providing torque in an opposite direction as reaction wheels, allowing the reaction wheels to spin down. Moreover, the enhanced spacecraft CoM management system can be used to establish wider dynamic range of attitude adjustments for a given reaction wheel system. Fast/quick orientation changes of a spacecraft might still employ a small on-board RCS, such as cold-gas or hot-gas, gimbals, or reaction wheels. However, when thrusters are active or when experiencing an external force, the enhanced spacecraft CoM management system can shift mass on the spacecraft to induce torques and affect various orientation changes. The enhanced spacecraft CoM management system can shift mass on the spacecraft when thrusters are not active or external forces are not experienced. Even when a traditional RCS system employed, the enhanced spacecraft CoM management system can provide for a total mass of a spacecraft smaller than without the enhanced spacecraft CoM management system.

In one specific example, CoM 331 in FIG. 3 is shown closer to tank 2 which might have more propellant presently in tank 2 as compared to tank 1. This configuration can alter CoM 331 to a desired location with regard to the associated spacecraft, and any thrust provided by thrusters 310 would experience a slight directionality due to the offset of CoM 331. Control of propellant amounts in each tank 315-316 with pump 313 can further alter CoM 331 with respect to the associated spacecraft.

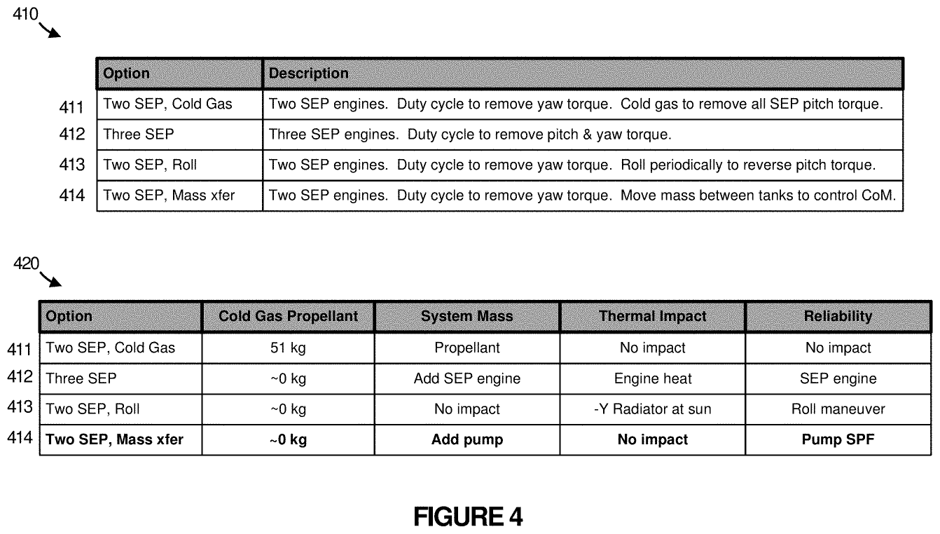

FIG. 4 illustrates a comparison among various SEP cruise configurations for an ADCS. Example configurations include those seen in FIGS. 2-3, among others. A first table 410 in FIG. 4 includes four example configurations among thrusters, components, and operations to affect torque on a spacecraft. In a first example configuration 411, two SEP thrusters are included on a spacecraft along with a cold-gas or hot-gas thruster system. In configuration 411, a duty cycle among the two SEP thrusters can be used to reduce/remove yaw torques on the spacecraft, while the cold-gas or hot-gas thruster can be used to reduce/remove pitch torque. In a second example configuration 412, three SEP thrusters are included on a spacecraft. In configuration 412, a duty cycle among the three SEP thrusters can be used to reduce/remove both yaw torques and pitch torques on the spacecraft, and no cold-gas or hot-gas thruster is required. In a third example configuration 413, two SEP thrusters are included on a spacecraft. In configuration 413, a duty cycle among the two SEP thrusters can be used to reduce/remove yaw torques on the spacecraft, while a roll operation is periodically performed to reverse pitch torques. In a fourth example configuration 414, two SEP thrusters are included on a spacecraft along with an enhanced spacecraft CoM management system. In configuration 414, a duty cycle among the two SEP thrusters can be used to reduce/remove yaw torques on the spacecraft. However, configuration 414 also advantageously moves mass between propellant tanks to control CoM.

As can be seen in the second table 420 of FIG. 4, performance of each of the four example configurations 411-414 of the first table 410 are compared. Configuration 411 that employs two SEP thrusters and cold-gas or hot-gas thrusters has a disadvantageously large propellent mass for the cold-gas or hot-gas thrusters. Configuration 412 that employs three SEP thrusters disadvantageously requires an additional SEP thruster, along with accompanying engine heat and reliability concerns. Configuration 413 that employs two SEP thrusters and roll operations can disadvantageously orient thermal radiators, antennae, or solar panels toward/away from the sun, leading to heating problems, energy deficits, and other issues. Moreover, configuration 413 requires additional and possibly complex roll operations, which might negatively affect the payload or available science measurements that can be performed during the roll. Finally, configuration 414 avoids the disadvantages of the first three example configurations by the movement of propellant mass among tanks. This fourth example configuration uses a pump or heater to induce pressure differentials among propellant tanks and transfer propellant mass among the tanks. A pump could be a single point of failure (SPF) if only one pump is employed in a non-redundant manner. However, redundant pump systems can be employed to mitigate this risk.

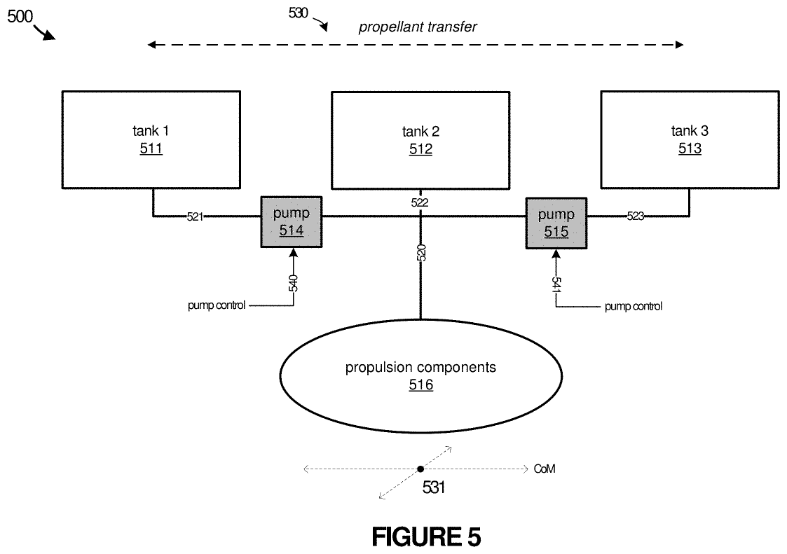

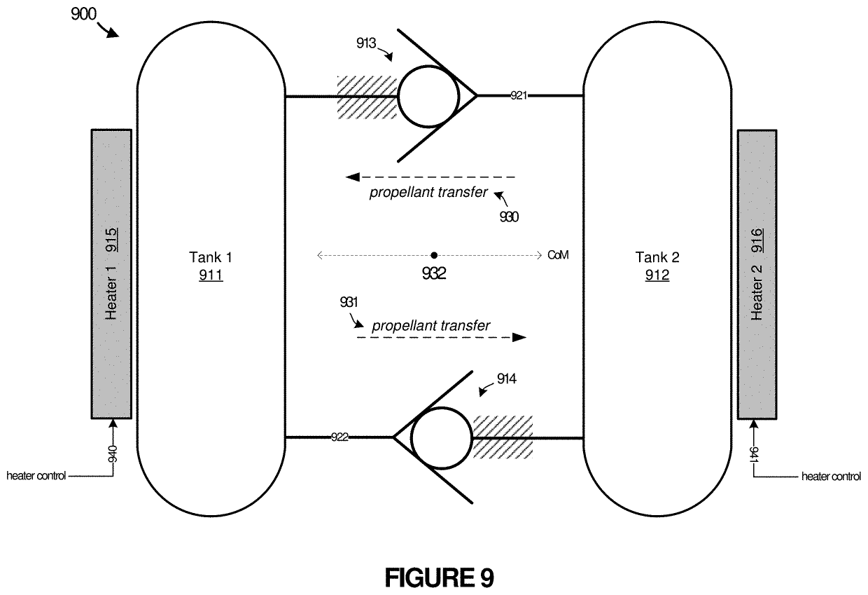

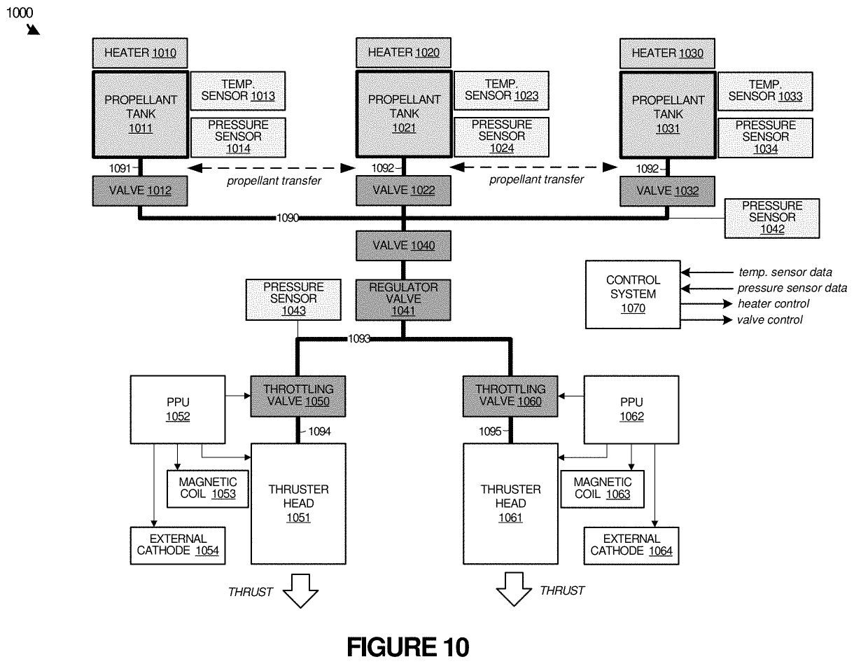

FIGS. 5-10 illustrate example tank and mass transfer topologies for enhanced spacecraft CoM management systems. Example pump placement and configurations are shown in FIGS. 5-8. It should be understood that a different configuration or quantity of individual pumps might instead be employed to move propellant mass between the various tanks. FIGS. 5-8 might instead employ heater-based mass transfer systems as discussed in FIGS. 9 and 10. FIGS. 9 and 10 might instead employ pump-based mass transfer systems. Propellant mass transfer might occur by providing for different drain rates from the associated tanks during thrust operations when propellant is provided to thrusters. However, when pumps are employed as seen in FIGS. 5-8, propellant is actively moved between the tanks at a higher flow rate than the corresponding spacecraft engine(s) employed for propulsion. Thus, while the spacecraft engines are actively receiving propellant, the included pumps can concurrently displace propellant mass from one tank to another, or among multiple tanks, to adjust or shift a CoM of the spacecraft.

In FIG. 5, an example tank topology 500 includes three (triple) tanks 511-513 coupled in parallel. Tanks 511-513 are coupled to propulsion components 516 over associated lines 520-523. Tanks 511-513 can have propellant transferred (530) between them by pumps 514-515 for shifting CoM 531 of an associated spacecraft. Depending on the placement and layout of tanks 511-513, the use of three tanks, in conjunction with a force applied by a spacecraft thruster or external force such as solar pressure acting on the spacecraft, can provide for attitude control of a spacecraft in two axes, namely using up/down/left/right torque control. Pumps 514-515 are included to perform mass transfers between tanks 511-513, and are controlled/powered over associated links 540-541. Line 520 provides propellant to propulsion components 516. Line 520 receives propellant from all three tanks in FIG. 5. Propulsion components 516 can include thrusters, lines, and any associated support hardware components and thruster control components.

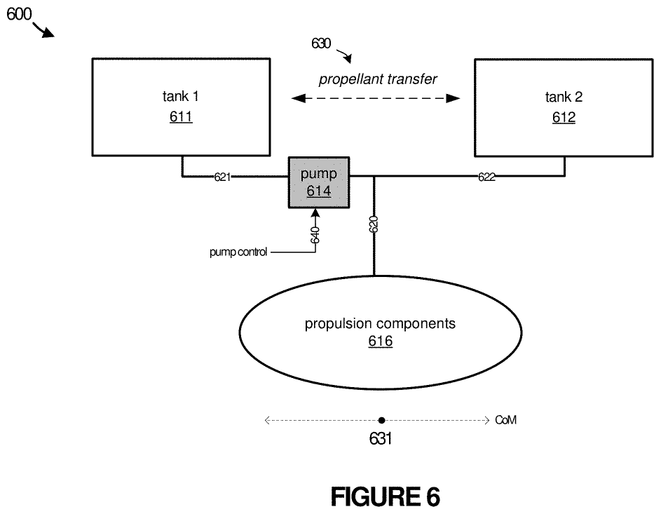

In FIG. 6, an example tank topology 600 includes two (double) tanks 611-612 coupled in parallel. Tanks 611-612 are coupled to propulsion components 616 over associated lines 620-622. Tanks 611-612 can have propellant transferred (630) between them by pump 614 for shifting CoM 631 of an associated spacecraft. Depending on the placement and layout of tanks 611-612, the use of two tanks, in conjunction with a force applied by a spacecraft thruster or external force such as solar pressure acting on the spacecraft, can provide for attitude control of a spacecraft in one axis, namely using left/right torque control or up/down torque control. Pump 614 is included to perform mass transfers between tanks 611-612, and is controlled/powered over associated link 640. Line 620 provides propellant to propulsion components 616. Line 620 receives propellant from both tanks in FIG. 6. Propulsion components 616 can include thrusters, lines, and any associated support hardware components and thruster control components.

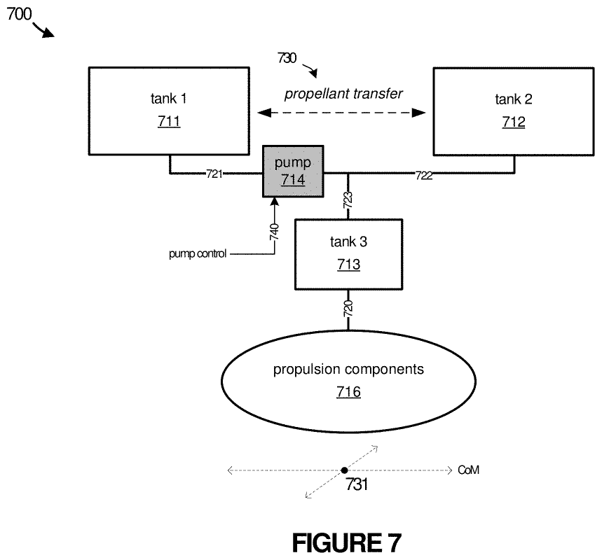

In FIG. 7, an example tank topology 700 includes two (double) tanks 711-712 coupled in parallel with an additional downstream accumulator tank 713. Tanks 711-712 are coupled to each other over associated lines 721-722, while tank 713 is coupled to tanks 711-712 over line 723 and to propulsion components 716 over line 720. Tanks 711-712 can have propellant transferred (730) between them by pump 714 for shifting CoM 731 of an associated spacecraft. Tank 713 is employed between tanks 711-712 as a buffer against pressure transients generated by the propellant transfer among tanks 711-712. Tank 713 can protect spacecraft components, such as downstream thrusters from possible pressure transients. Depending on the placement and layout of tanks 711-713, the use of three tanks, in conjunction with a force applied by a spacecraft thruster or external force such as solar pressure acting on the spacecraft, can provide for attitude control of a spacecraft in two axes, namely using up/down/left/right torque control. Pump 714 is included to perform mass transfers between tanks 711-712, and is controlled/powered over associated link 740. Line 720 receives propellant from tank 713 in FIG. 7. Propulsion components 716 can include thrusters, lines, and any associated support hardware components and thruster control components.

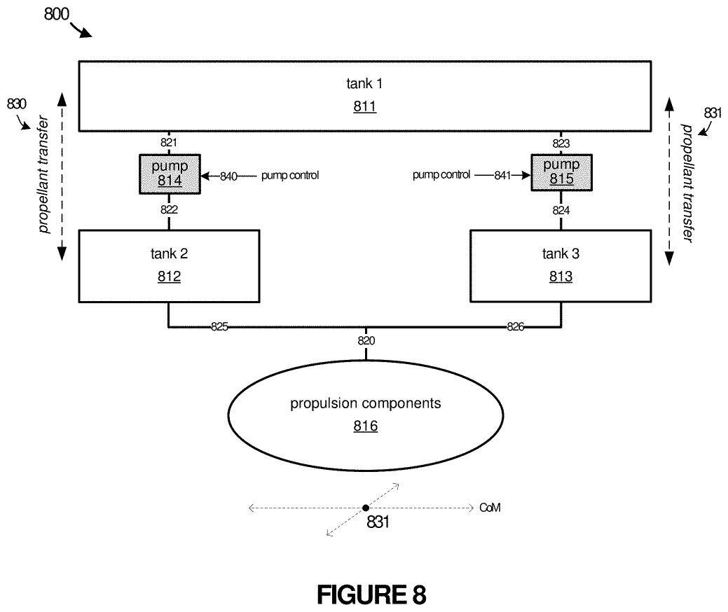

In FIG. 8, an example tank topology 800 includes primary tank 811 coupled to two (double) downstream accumulator tanks 812-813 coupled in parallel. The example in FIG. 8 is not limited to three tanks, and instead could include more than two downstream tanks, more than one primary tank, and associated pumping mechanisms. Tanks 812-813 are coupled to each other over associated lines 825-826 and coupled to propulsion components 816 over line 820. Tank 811 is coupled to tank 812 over lines 821-822 through pump 814. Pump 814 is controlled/powered over link 840. Tank 811 is coupled to tank 813 over lines 823-824 through pump 815. Pump 815 is controlled/powered over link 841. Tanks 812-813 can have propellant transferred (830) into them differentially from tank 811 shifting CoM 831 of an associated spacecraft. Tank 811 is employed as a propellant source/sink for tanks 812-813. Depending on the placement and layout of tanks 811-813, the use of three tanks, in conjunction with a force applied by a spacecraft thruster or external force such as solar pressure acting on the spacecraft, can provide for attitude control of a spacecraft in two axes, namely using up/down/left/right torque control. Line 820 receives propellant from tanks 811-812 in FIG. 8. Propulsion components 816 can include thrusters, lines, and any associated support hardware components and thruster control components.

FIGS. 9-10 illustrate an alternative arrangement to using mechanical pumps to transfer, shift, or otherwise move propellant among propellant tanks on a spacecraft. In FIGS. 9-10, a heater-based system is employed to provide a differential pressure among tanks which moves propellant for shifting CoM 932 of an associated spacecraft. In FIG. 9, two tanks 911-912 are employed with associated heaters 915-916. Heaters 915-916 can be electrical/resistive heating elements, solid-state heating elements, waste heat-based heating elements, parasitic heat-based heating elements, solar heating elements, or others. Heaters 915-916 can be controlled/powered over associated links 940-941. A temperature differential among tanks 911-912 is established using heaters 915-916. A directionality of propellant transfer/flow (931-932) can thus be controlled using this differential heating to alter a mass of propellant in each tank 911-912. Valves 913-914 can be employed across associated lines 921-922, as shown in FIG. 9, to further control propellant flow to a desired tank. In this manner, the use of on-board pumps for mass transfer between propellant tanks can be reduced or eliminated. Valves 913-914 can comprise check valves, one-way valves, non-return valves, or other types of valves.

FIG. 10 shows a detailed block diagram 1000 of an example heater-based spacecraft CoM management system. FIG. 10 shows a system which includes three propellant tanks 1011, 1021, and 1031 along with associated heaters 1010, 1020, and 1030. Heaters 1010, 1020, and 1030 are mounted to, or mounted in close proximity to, corresponding propellant tanks 1011, 1021, and 1031. Temperature monitoring elements and associated circuitry, such as temperature sensors 1013, 1023, and 1033 are included to measure a current temperature of each propellant tank. Further temperature sensors can be included for ambient temperature sensing and for closed-loop monitoring/control of each heater. Pressure monitoring elements and associated circuitry, such as pressure sensors 1014, 1024, and 1034 are included for each propellant tank to monitor a current pressure of each propellant tank. Sensors 1013, 1014, 1023, 1024, 1033, and 1034 can be communicatively coupled to a control system or control circuitry (not shown in FIG. 10 for clarity) for monitoring of associated sensor data. Sensor data related to temperature or pressure can be provided to this control system or control circuitry to monitor and control distribution of propellant mass among tanks 1011, 1021, and 1031. Valves 1012, 1022, and 1032 can be included for corresponding tanks 1011, 1021, and 1031 to control input/output of propellant along associated propellant lines 1090-1092. Control of heaters 1010, 1020, and 1030 and valves 1012, 1022, and 1032 of FIG. 10 can control distribution of propellant mass among tanks 1011, 1021, and 1031 without the use of pumps. Heaters 1010, 1020, and 1030 can be activated to produce a controlled pressure differential among tanks 1011, 1021, and 1031, which along with valves 1012, 1022, and 1032, can move propellant mass into a desired tank from one or more source tanks. This transfer or shifting of propellant mass can adjust center of mass (CoM) of an associated spacecraft and induce a torque exhibited on the spacecraft during thrusting operations or during application of an external force on the spacecraft. Depending on the placement and layout of tanks 1011, 1021, and 1031, the use of three or more tanks can provide for attitude control of a spacecraft in two axes, namely using up/down/left/right torque control.

Heaters 1010, 1020, and 1030 can produce a net pressure among tanks 1011, 1021, and 1031 to drive one or more thrusters from one, two, or all three of the propellant tanks. FIG. 10 includes two thrusters, indicated by thruster heads 1051 and 1061. Further valves can be included to separate a CoM adjustment system from a propulsion or thruster system. In FIG. 10, valve 1040 is include to separate thruster heads 1051 and 1061 from tanks 1011, 1021, and 1031. Regulator valve 1041 can be employed to control flow of propellant to one or more thrusters over line 1093, such as the two thrusters shown in FIG. 10. Various control circuitry, control valves can be employed to further control flow of propellant to thruster elements. The thruster elements themselves can include control units, magnetic coil elements, cathode elements, thruster heads, and other elements specific to the particular thruster technology. In FIG. 10, thruster head 1051 has associated throttling valve 1050 and receives propellant over line 1094. Power Processing Unit (PPU) 1052 controls operation of thruster head 1051 as well as operation of magnetic coil 1053 and cathode 1054. Thruster head 1061 has associated throttling valve 1060 and receives propellant over line 1095. PPU 1062 controls operation of thruster head 1061 as well as operation of magnetic coil 1063 and cathode 1064. PPU 1052 and PPU 1062 can each provide electrical power to associated thruster elements, which originates from corresponding power sources discussed herein.

Control system 1070 is also included in FIG. 10. Control system 1070 can comprise microprocessors or processing circuitry that executes one or more control schemes for altering a CoM of a spacecraft associated with tanks 1011, 1021, and 1031. Control system 1070 might comprise elements discussed above for processing system 103 or logistics 104 in FIG. 1, including elements of attitude adjustment system 130 that employs attitude adjustment parameters 120 and attitude adjustment control 121. Attitude adjustment parameters 120 can comprise any of the sensor data discussed in FIG. 10 for pressure or temperature, among other sensor data. Control system 1070 can establish feedback control loops or control schemes that provide power to heaters 1010, 1020, and 1030 while monitoring at least the pressures or temperatures of tanks 1011, 1021, and 1031. Although the elements and operations of FIG. 10 are shown for heaters or heating elements, similar elements and techniques can be applied to control of one or more pumps.

In operation, control system 1070 can receive sensor data from pressure sensors 1014, 1024, 1034, 1042, and 1043 over associated communication links (not shown in FIG. 10 for clarity). Control system 1070 can receive sensor data from temperature sensors 1013, 1023, and 1033 over associated communication links (not shown in FIG. 10 for clarity). Control system 1070 can also monitor CoM state and other information about the associated spacecraft to determine adjustments to CoM of the spacecraft. Based on these adjustments, control system 1070 can apply power to one or more among heaters 1010, 1020, and 1030 to produce pressure differentials among associated tanks 1011, 1021, and 1031. Control system 1070 can then activate or inactivate various ones among valves 1012, 1022, and 1032 to transfer propellant among 1011, 1021, and 1031 to produce changes in the CoM of the spacecraft. Control system 1070 can also control various ones among valves 1040, 1041, 1050, and 1060 to direct propellant from tanks 1011, 1021, and 1031 to thruster heads 1051 and 1061. Control system 1070 might receive indications from PPU 1052 and 1062 to determine when thruster heads 1051 and 1061 are active, and ensure that propellant transfers among tanks 1011, 1021, and 1031 occurs during active thrusting operations or to offset imbalances during application of external forces on the spacecraft. Furthermore, pressure sensors 1042 and 1043 can be monitored by control system 1070 for safety monitoring of associated propellant lines and for feedback to regulate associated valves on the propellant lines.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the disclosure. Those skilled in the art will also appreciate that the features described above can be combined in various ways to form multiple implementations. As a result, the invention is not limited to the specific implementations described above, but only by the claims and their equivalents.

What is claimed is:

1. A method of operating a spacecraft, the method comprising:
providing propellant in two or more propellant tanks for use by at least a thruster of the spacecraft; and
during application of a force on the spacecraft, transferring propellant from at least a first propellant tank to at least a second propellant tank to alter a center of mass of the spacecraft.

2. The method of claim 1, wherein altering the center of mass of the spacecraft is configured to at least desaturate one or more reaction wheels of the spacecraft.

3. The method of claim 1, wherein altering the center of mass of the spacecraft is configured to perform attitude control of the spacecraft in one axis comprising one among left/right torque control and up/down torque control.

4. The method of claim 1, wherein the spacecraft comprises at least three propellant tanks, and wherein altering the center of mass of the spacecraft is configured to at least perform attitude control of the spacecraft in two axes comprising up/down/left/right torque control.

5. The method of claim 1, further comprising:
transferring the propellant from at least the first propellant tank to at least the second propellant tank with at least one pump.

6. The method of claim 1, further comprising:
transferring the propellant from at least the first propellant tank to at least the second propellant tank with at least one heating element configured to adjust a pressure of at least one among the first propellant tank and the second propellant tank.

7. The method of claim 1, further comprising:
transferring at least a portion of the propellant to at least the thruster performing thrusting operations during transfer of the propellant from at least the first propellant tank to at least the second propellant tank.

8. A spacecraft, comprising:
at least two propellant tanks;
an adjustment system configured to move propellant among the at least two propellant tanks; and
a control system configured to control the adjustment system to alter a center of mass of the spacecraft during application of a force on the spacecraft.

9. The spacecraft of claim 8, wherein the control system is configured to alter the center of mass of the spacecraft during thrusting operations of the spacecraft.

10. The spacecraft of claim 9, comprising:
the adjustment system configured to transfer at least a portion of the propellant to one or more thrusters performing the thrusting operations during transfer of the propellant among the at least two propellant tanks.

11. The spacecraft of claim 8, wherein the adjustment system comprises a pump configured to move the propellant among the at least two propellant tanks.

12. The spacecraft of claim 8, wherein the adjustment system comprises a heating element configured to adjust a pressure of at least one of the propellant tanks to move the propellant among the at least two propellant tanks.

13. The spacecraft of claim 8, wherein altering the center of mass of the spacecraft is configured to at least desaturate one or more reaction wheels of the spacecraft.

14. The spacecraft of claim 8, wherein altering the center of mass of the spacecraft is configured to perform attitude control of the spacecraft in one axis comprising one among left/right torque control and up/down torque control.

15. The spacecraft of claim 8, comprising:
a third propellant tank; and
wherein altering the center of mass of the spacecraft is configured to at least perform attitude control of the spacecraft in two axes comprising up/down/left/right torque control.

16. The spacecraft of claim 8, wherein the at least two propellant tanks comprise:
a first propellant tank employed by the adjustment system to alter the center of mass of the spacecraft;
a second propellant tank employed by the adjustment system to alter the center of mass of the spacecraft; and
a third propellant tank comprising a downstream accumulator tank positioned between the at least two propellant tanks and one or more thrusters of the spacecraft.

17. The spacecraft of claim 8, wherein the at least two propellant tanks comprise:
a first propellant tank configured to provide at least a first portion of the propellant to one or more thrusters of the spacecraft;
a second propellant tank configured to provide at least a second portion of the propellant to one or more thrusters of the spacecraft; and
a third propellant tank coupled to the first propellant tank and the second propellant tank and configured to supply or receive propellant from the first propellant tank and the second propellant tank to alter the center of mass of the spacecraft.

18. A spacecraft, comprising:
at least one reaction wheel configured to produce a torque on the spacecraft;
at least two propellant tanks;
an adjustment system configured to move propellant among the at least two propellant tanks; and
a control system configured to control the propellant management system to desaturate the at least one reaction wheel during application of a force on the spacecraft.

19. The spacecraft of claim 18, comprising:
at least one pump configured to transfer the propellant from at least a first propellant tank to at least a second propellant tank.

20. The spacecraft of claim 18, further comprising:
at least one heating element configured to adjust a pressure of at least one propellant tank to transfer the propellant among the at least two propellant tanks.
